(19) United States
(12) Patent Application Publication
(10) Pub. No.: US 2026/0044393 A1
(43) Pub. Date: Feb. 12, 2026

(54) SYSTEMS AND METHODS FOR COLLECTING AND DISTRIBUTING DIGITAL INFORMATION

(71) Applicant: The PNC Financial Services Group, Inc., Pittsburgh, PA (US)

(72) Inventors: Michael NITSOPOULOS, Pittsburgh, PA (US); Brian WARGO, Washington, PA (US); Jerold XING, Richmond Hill (CA)

(73) Assignee: The PNC Financial Services Group, Inc., Pittsburgh, PA (US)

(21) Appl. No.: 18/972,289

(22) Filed: Dec. 6, 2024

Related U.S. Application Data
(60) Provisional application No. 63/679,999, filed on Aug. 6, 2024.

(51) Int. Cl. G06F 9/54

(52) U.S. Cl. CPC G06F 9/541

(57) ABSTRACT

A computer-implemented system for collecting and distributing digital information, which may include: a channel application and a plurality of micro-applications, hosted within the channel application and deployed on a server, configured to perform one or more functions, and each including a front-end interface receiving a first digital information from a user and displaying a second digital information to the user through a Micro-User Interface and an outer API transferring the first digital information to a database and retrieving the second digital information from the database by orchestrating one or more calls to at least one inner API, wherein the front-end interface, the outer API, and the at least one inner API are deployed within a single pod configured to isolate and enable exchange of the first and second digital information between the front-end interface, the outer API, and the at least one inner API.

### BACKGROUND

### Technical Field

The present disclosure relates generally to computer-implemented systems and methods for collecting and distributing digital information. More specifically, and without limitation, this disclosure relates to computer-implemented systems and methods for collecting and distributing digital information using digital applications in a computer system architecture having one or more micro-applications and a central data location. The systems and methods disclosed herein may be used in various systems that benefit from building functionality in small, discrete pieces, and systems comprising various sources of digital experience information and/or systems of record.

### Background Information

In digital application systems, it is often desirable to build functionality in small, discrete pieces commonly referred to as “micro-applications.” Micro-applications allow digital application developers to work independently from one another on separate features and functions. They also allow developers to avoid rewriting code for the same tasks when developing new applications. Existing systems and methods for developing micro-applications, however, suffer from a number of drawbacks, including the inability to standardize the communication pattern between micro-applications, requiring specific code to be written for two or more micro-applications to share information. In addition, existing systems and methods are inefficient in that micro-applications are coupled through dependencies, resulting in micro-applications that are not self-reliant but rather rely on functions and outputs from other applications or micro-applications. Furthermore, existing systems and methods are cumbersome to use by developers, leading to degradation of code quality.

Moreover, in digital application systems, it is often desirable to collect information in a central accessible data location. A central data location simplifies storage and retrieval of information, allowing disparate systems to capture and share data. It also simplifies integration of new features, allowing data collected from an existing system to be used by a new system, which, for example, reduces the time needed to release new features and applications. Existing systems and methods for processing digital information, however, suffer from a number of drawbacks, including the inability to provide real-time information. In addition, existing systems and methods are unable to perform deep data exploration, since handling large data with existing systems of record is cost prohibitive. Furthermore, existing systems and methods are cumbersome to use in that they require complex integration and intricate data schema designs to operate.

### SUMMARY

In view of the foregoing, embodiments of the present disclosure provide computer-implemented systems and methods for processing digital experience information. The description below provides exemplary aspects of some computer-implemented systems and methods for processing digital experience information in accordance with some exemplary embodiments. Aspects may be combined with one or more suitable described aspects or other undescribed aspects. Aspects of one exemplary system or method may be combined with aspects of other exemplary systems, methods, or both.

In an embodiment, a computer-implemented system for distributing digital information is disclosed. The system may include a memory storing instructions; and one or more processors of a server configured to execute the stored instructions to provide: a channel application that is accessible by a processing unit of a user device; and a plurality of micro-applications, hosted within the channel application and deployed on the server. Each micro-application may be configured to perform one or more functions, and each micro-application may include a front-end interface and an outer Application Programming Interface (API). The front-end interface may receive a first digital information from a user via the user device and display a second digital information to the user via the user device through a Micro-User Interface (micro-UI). The outer API may transfer the first digital information received from the user via the front-end interface to a database and retrieve the second digital information for display to the user from the database by orchestrating one or more calls to at least one inner API deployed on the server. The front-end interface, the outer API and the at least one inner API may be deployed on the server within a single pod, the single pod being associated with each micro-application and the at least one inner API. The single pod may be configured to isolate and enable exchange of the first and second digital information between the front-end interface, the outer API, and the at least one inner API.

The at least one inner API may include a write inner API and/or a read inner API.

The write inner API may be configured to receive the transferred first digital information from the outer API and write the transferred first digital information to a System Of Record (SOR) coupled to the database.

The read inner API may be configured to retrieve the second digital information from a book of reference included in the database via a Data Streaming Platform (DSP) and transfer the retrieved second digital information to the outer API.

The outer API may include an external API configured to be exposed to an external system.

The front-end interface, the outer API, and the at least one inner API may be deployed in separate containers within the single pod.

The front-end interface, the outer API, and the at least one inner API may be containerized into the separate containers using a containerization platform.

Each separate container may include a respective port for exchanging digital information.

Each respective port may be coupled to a gateway within the single pod.

The gateway may be configured to enable the exchange of the first and second digital information between the user and the separate containers within the single pod.

The front-end interface, the outer API, and the at least one inner API may exchange the first and second digital information via a local host using the respective port of the separate containers.

Each micro-application and the at least one inner API may be deployed in the single pod via a container orchestration platform.

The outer API may be further configured to process the retrieved second digital information.

Processing the retrieved second digital information may include filtering the retrieved second digital information to match requirements of the front-end interface.

The requirements of the front-end interface may be based on at least one of the channel application or the user device.

Processing the retrieved second digital information may include converting a data format of the retrieved second digital information into a structure that is optimized for use by the front-end interface.

In another embodiment, a non-transitory computer-readable medium for implementing a system for collecting and distributing digital information is disclosed. The non-transitory computer-readable medium may include instructions that, when executed by a processor cause the processor to: provide a channel application that is by a processing unit of a user device; deploy a plurality of micro-applications, wherein the plurality of micro-applications are hosted within the channel application on a server, configure each micro-application of the plurality of micro-applications to perform one or more functions; configure each micro-application to include a front-end interface and an outer Application Programming Interface (API); configure the front-end interface to receive a first digital information from a user via the user device and display a second digital information to the user via the user device through a Micro-User Interface (micro-UI); configure the outer API to transfer the first digital information received from the user via the front-end interface to a database and retrieve the second digital information to be displayed to the user from the database by orchestrating one or more calls to at least one associated inner API deployed on the server; deploy the front-end interface, the outer API and the at least one inner API on the server within a single pod, the single pod being associated with each micro-application and the at least one inner API; and configure the single pod to isolate and enable exchange of the first and second digital information between the front-end interface, the outer API, and the at least one inner API.

The at least one inner API may include a write inner API and/or a read inner API.

The write inner API may be configured to receive the transferred first digital information from the outer API and write the transferred first digital information to a System Of Record (SOR) coupled to the database.

The read inner API may be configured to retrieve the second digital information from a book of reference included in the database via a Data Streaming Platform (DSP) and transfer the retrieved second digital information to the outer API.

The outer API may include an external API configured to be exposed to an external system.

The processor may be further configured to deploy the front-end interface, the outer API, and the at least one inner API in separate containers within the single pod.

The processor may be further configured to containerize the front-end interface, the outer API, and the at least one inner API into separate containers using a containerization platform.

Each separate container may include a respective port for exchanging digital information.

The processor may be further configured to couple each respective port to a gateway within the single pod.

The processor may be further configured to configure the gateway to enable the exchange of the first and second digital information between the user and the separate containers within the single pod.

The processor may be further configured to configure the front-end interface, the outer API, and the at least one inner API to exchange the first and second digital information via a local host using the respective port of the separate containers.

The processor may be further configured to deploy each micro-application and the at least one inner API in the single associated pod via a container orchestration platform.

The processor may further configure the outer API to process the retrieved second digital information.

Configuring the outer API to process the retrieved second digital information may include configuring the outer API to filter the retrieved second digital information to match requirements of the front-end interface.

The requirements of the front-end interface may be based on at least one of the channel application or the user device.

Configuring the outer API to process the retrieved second digital information may include configuring the outer API to convert a data format of the retrieved second digital information into a structure that is optimized for use by the front-end interface.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a narrative illustration portraying the challenges associated with a single-container-per-pod approach for developing and deploying a plurality of micro-applications.

FIG. 1B is a narrative illustration portraying a single-pod approach for developing and deploying a plurality of micro-applications.

FIG. 1C is a schematic representation of exemplary computer-implemented systems for collecting and distributing digital experience information, consistent with some embodiments of the present disclosure.

FIG. 2A is a schematic illustration of an exemplary deployment unit, consistent with some embodiments of the present disclosure.

FIG. 2B is a schematic illustration of another exemplary deployment unit, consistent with some embodiments of the present disclosure.

FIG. 3 is a schematic illustration of the single pod deployment model for the deployment unit of FIG. 2A, consistent with some embodiments of the present disclosure.

FIG. 4 is a flowchart of an exemplary process, including instructions for obtaining a computer-implemented system for collecting and distributing digital information, consistent with some embodiments of the present disclosure.

FIG. 5 is a block diagram of an exemplary computing system environment that may be employed in connection with some embodiments of the present disclosure.

### DETAILED DESCRIPTION

The following detailed description refers to the accompanying drawings. Wherever possible, the same reference numbers are used in the drawings and the following description to refer to the same or similar parts. Unless otherwise defined, technical and/or scientific terms have the meaning commonly understood by one of ordinary skill in the art. The disclosed embodiments are described in sufficient detail to enable those skilled in the art to practice the disclosed embodiments. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

In digital application systems, building functionality in small, discrete pieces, commonly referred to as “micro-applications,” is often highly desirable. Micro-applications enable developers to work independently on separate features and functions, fostering greater flexibility and parallel development. Micro-applications themselves may be composed of various blocks or components, also known as containers. This additional level of granularity further enhances the development process by allowing developers to focus on specific parts of the application. For instance, some blocks (front-end blocks) may be dedicated to the user interface and user experience aspects of the micro-application, other blocks (back-end blocks) may handle the server-side logic, data processing, and business rules, and additional blocks (communication blocks) may manage communication with central data repositories or external services. Micro-application blocks refer to lightweight, standalone, and executable packages that may include everything needed to run a piece of software. For example, each block may encapsulate code, runtime, system tools, libraries, and settings. These blocks are self-contained units that can function independently. They can also be combined with other blocks to build more complex systems, such as a full-fledged micro-application.

Some micro-application blocks may be unique to a particular micro-application, tailored to its specific needs and functions. Conversely, other blocks may be common or shared across multiple micro-applications, promoting code reuse and consistency throughout the system, thereby reducing redundancy and facilitating maintenance. For example, a digital banking platform composed of various micro-applications may include User Account Management, Transaction Processing, and Customer Support micro-applications. The User Account Management micro-application may have front-end blocks for the user dashboard, back-end blocks for managing user data, and communication blocks for interacting with a central user database. The Transaction Processing micro-application might include blocks for transaction entry forms, backend processing logic, and communication blocks for real-time financial data synchronization. The Customer Support micro-application may consist of blocks for a support ticket interface, backend blocks for ticket management, and communication blocks to access user and transaction data for support purposes. In this scenario, certain blocks, such as authentication and user profile management, may be shared across all three micro-applications, ensuring a consistent user experience and simplifying the overall system architecture.

Once the different micro-application blocks (containers) are created, an additional layer of abstraction may be added to manage and deploy them, making the micro-application blocks available for use (i.e., moving a block from a development environment, where it is built and tested by developers, to a production environment where it is used by users). This layer, known as a “pod,” represents the smallest unit of deployment. The industry-wide preference is for small, nimble pods that include a single container. This preference arises from the efficiency gains associated with rapid pod deployment and teardown, particularly evident in smaller pod configurations that consume fewer resources and start up more quickly. However, different challenges are associated with this single-container-per-pod approach such as ensuring reliable inter-service communication among micro-application blocks, complicated by issues like latency, network failures, and serialization overhead. Managing deployments individually for each micro-application block increases operational complexity and risks version mismatches. Moreover, varying resource requirements across blocks necessitate careful allocation to avoid inefficiencies and potential contention. Maintaining data consistency and synchronization across separately deployed components poses further challenges, exacerbated by the complex aggregation of monitoring data and logs from disparate sources. Additionally, securing communication and managing network policies between different components adds another layer of complexity to deployment and maintenance processes.

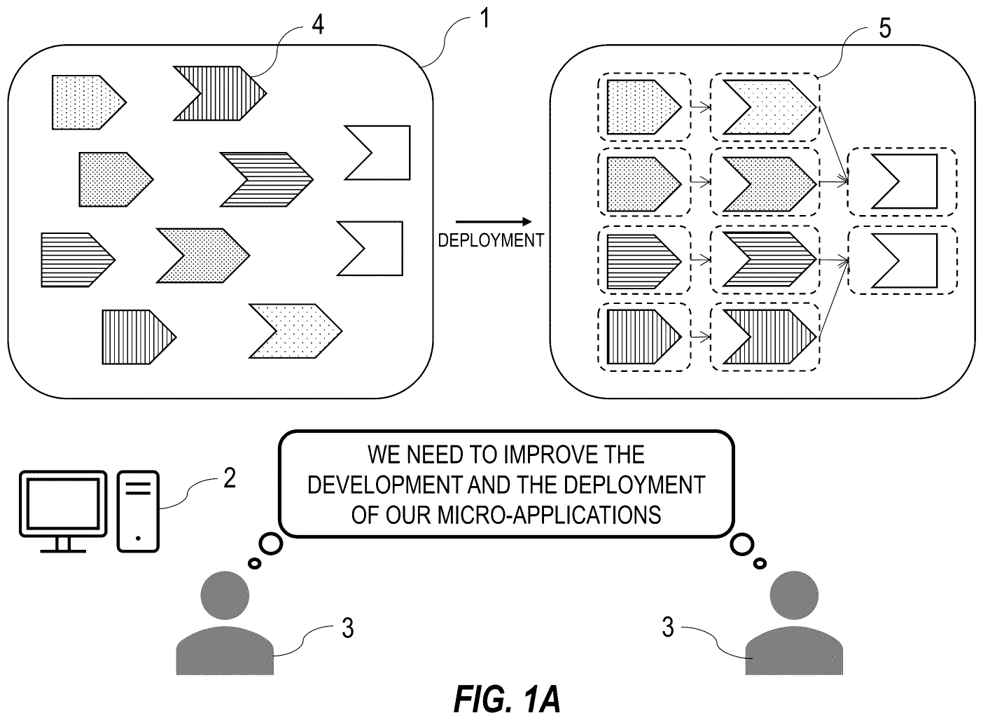

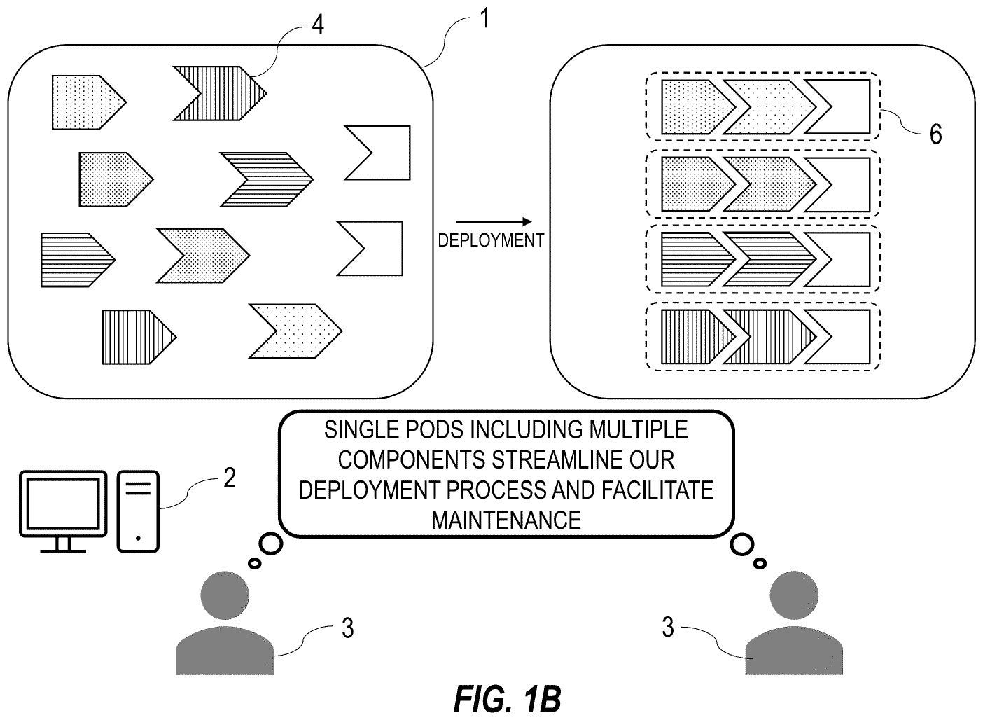

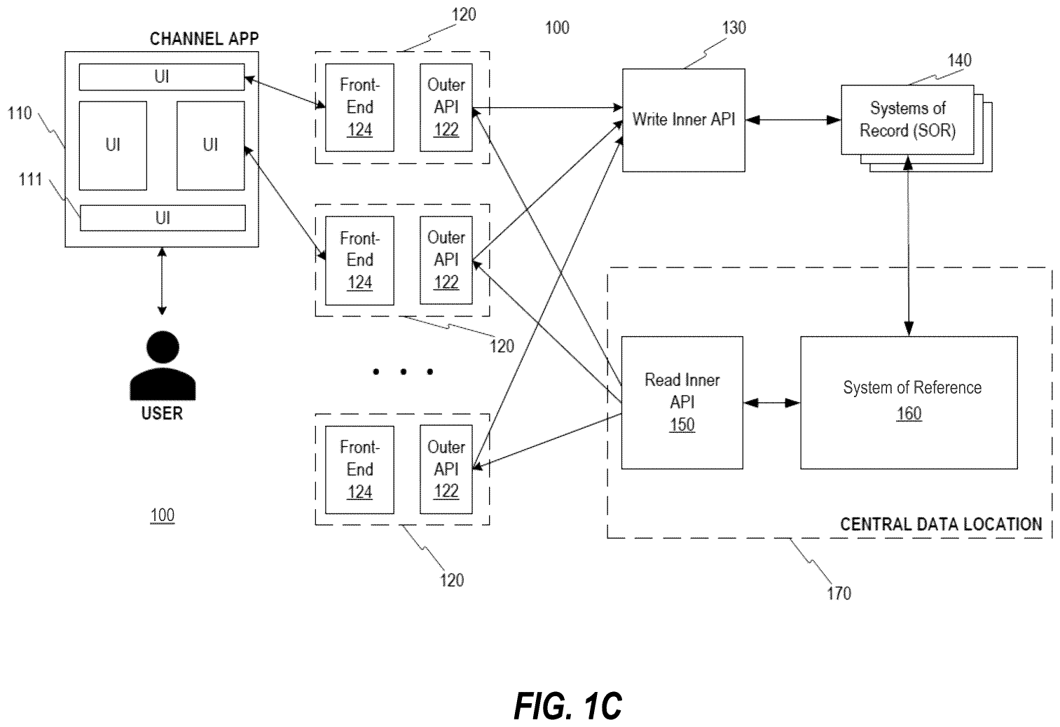

FIG. 1A is a narrative illustration portraying the challenges associated with the single-container-per-pod approach for developing and deploying different micro-applications 1 within a computer system 2. FIG. 1A depicts a team of developers 3 collaboratively addressing these challenges. In this scenario, there are four different micro-applications 1 that need deployment. Each micro-application consists of three micro-application blocks or containers. Pattern-coded blocks represent those unique to a specific micro-application, while white blocks denote those that can be reused across different micro-applications. The deployment operation involves deploying each individual micro-application block (container) 4 in a dedicated pod 5 and subsequently connecting the various pods 5 to make the different micro-applications 1 available for use. As illustrated, certain pods containing a white block are connected to multiple pods, reflecting shared components across different micro-applications. In scenarios where the number of micro-applications 1 ranges into the hundreds, with each having a variable number of micro-application blocks, this approach necessitates complex routing configurations. The challenge intensifies with the need to maintain consistent performance, secure communication, and secure data synchronization across a highly dynamic and scalable environment. In terms of maintenance, diagnosing and resolving issues becomes increasingly complex when employing multiple pods, as tracing the interdependencies between various components scattered across different pods is challenging. In light of these challenges, a development team may opt for an alternative strategy to improve the development and deployment of micro-applications.

One alternative approach may involve bundling the different micro-application components (containers) together into a single pod (multi-container per pod approach). This single-pod arrangement, where each single pod includes multiple containers, can offer several advantages. Streamlined communication between components within the pod is one benefit, as containers can interact directly without the need for external network communication, reducing latency and potential points of failure. Simplified development and maintenance support may be also achieved, as developers can manage and update related components together, ensuring compatibility and reducing operational complexity. Clear data entry points within the pod may facilitate more straightforward data handling and consistency. By consolidating functionality into single pods, the deployment process may become more secure and efficient. This approach may eliminate the need for complex routing configurations that would be necessary if each component were deployed in separate pods. Additionally, intra-pod communication may benefit from inherent security features, reducing the attack surface and mitigating security concerns related to inter-pod traffic. Deploying multiple pods, where each pod independently accepts traffic, may raise potential security concerns regarding intra-pod traffic control and expose each pod to a wider array of external threats. Furthermore, this approach facilitates targeted issue resolution. When a problem arises, it is easier to identify and address the issue within a specific micro-application feature housed in a single pod. This localization of functionality means that performance bottlenecks, bugs, or other issues may be quickly isolated and resolved without impacting other components of the system. The cohesive nature of a single pod with multiple containers may ensure that troubleshooting and maintenance efforts are more focused and effective, enhancing the overall reliability and maintainability of the system. Overall, bundling micro-application components into single pods with multiple containers may enhance efficiency, security, and maintainability, offering a robust solution to the complexities of microservice architecture. Despite some drawbacks, such as potentially more cumbersome deployments and the duplication of certain containers, the benefits often outweigh these challenges.

FIG. 1B illustrates the alternative single-pod approach. In contrast to the scenario depicted in FIG. 1A, this deployment strategy involves placing all the different micro-application blocks (containers) 4 of a given micro-application 1 into a single pod 6. As shown, some white blocks have been duplicated, reflecting shared functionalities across different micro-applications. While this results in some redundancy, the single-pod deployment approach simplifies the overall routing configuration. By clearly delineating the functionality of each micro-application 1 within individual pods 6, the deployment process becomes more straightforward. This approach enhances maintainability, as each pod encapsulates a complete micro-application, making it easier to manage, update, and troubleshoot. Moreover, the single-pod deployment approach improves security and efficiency by reducing the complexity of inter-component communication and ensuring that all necessary components are contained within a single, cohesive unit.

Some embodiments of the present disclosure may involve a computer-implemented system for collecting and distributing digital information. The computer-implemented system may include a memory storing instructions and one or more processors of a server configured to execute the stored instructions to provide a channel application that is accessible by a processing unit of a user device, and a plurality of micro-applications, hosted within the channel application and deployed on the server. Each micro-application may be configured to perform one or more functions. In the context of this disclosure, a channel application, also referred to as a “driver application”, refers to a software platform designed to host and manage multiple micro-applications. A channel application may serve as a centralized interface through which these micro-applications can operate, interact, and be accessed by users. The channel application may provide the necessary infrastructure, resources, and integration points to ensure that each micro-application functions correctly and can communicate with other micro-applications or external systems. A channel application may also handle user authentication, data routing, and overall system orchestration to streamline the deployment, monitoring, and management of the micro-applications it hosts. Conversely, a micro-application refers to a small, independent software component designed to perform specific functions within a larger system. Each micro-application may be focused on a particular task/business function or set of tasks/business functions, making it modular and easily manageable. Micro-applications may operate autonomously but may interact with other micro-applications through well-defined interfaces, such as APIs. The computer-implemented system for collecting and distributing digital information may therefore leverage the modularity and flexibility of micro-applications within a centralized channel application. The channel application may act as the front-end client interface, managing user interactions, authentication, data routing, and system orchestration. Each micro-application, with its front-end and back-end components, may perform specific tasks, allowing for independent development, deployment, and scaling. This modular approach may allow for greater flexibility, scalability, and ease of maintenance, as each micro-application can be developed, deployed, updated, and scaled independently of others.

In some embodiments, each micro-application of the plurality of micro-applications may include a front-end interface and an outer Application Programming Interface (API). The front-end interface of a micro-application refers to the user-facing part of the software system. The front-end interface may be designed to interact directly with users, presenting information and receiving inputs. For example, in some embodiments, the front-end interface may receive a first digital information from a user via the user device and display a second digital information to the user via the user device through a Micro-User Interface (micro-UI). As used herein, the first digital information refers to the initial data or input provided by the user. For example, the first digital information could be a user entering search queries, filling out forms, or providing any other type of input. Conversely, the second digital information refers to the output or data presented back to the user based on the first digital information. For example, after processing a search query, the front-end interface may display the search results or show confirmation messages after a form is submitted. In some other embodiments exchange of digital information (e.g., first and/or second digital information) may be performed through other forms of user interaction (e.g., command-line interface, voice-user interface, biometric interface, Natural language Processing (NLP), or multi-modal interfaces). One of the purposes of the front-end interface may be to provide a user-friendly experience, allowing users to interact with and manipulate digital information in a way that is intuitive and accessible.

Outer APIs refer to interfaces utilized for channel applications/micro-applications or exposed to third parties. Outer APIs may serve as the bridge between the front-end and the back-end systems. Outer APIs may be tightly coupled with the front-end interface and be unique to each micro-application (e.g., user experience within the channel application). Outer APIs may be documented in a developer platform for developing digital experience applications. Such a platform may provide developers with a common user interface framework enabling the development of consistent and standard digital experience applications. In addition, a developer platform may provide developers with the toolkit, components, and libraries to ensure proper automated testing, debug and build patterns, and ensure that applications are built to architecturally approved standards.

In some embodiments, the outer API may transfer the first digital information received from the user via the front-end interface to a database and retrieve the second digital information for display to the user from the database by orchestrating one or more calls to at least one inner API deployed on the server. In other words, outer APIs may play a role in data transfer between front-end and back-end components within the server. For example, when a user interacts with the front-end interface of a micro-application within the channel application, providing input such as a search query or form submission (first digital information), the outer API may capture this input and transfer it to the back-end systems, specifically to a database, by making orchestrated calls to the inner APIs. The inner APIs may process the input, perform necessary computations or data retrieval, and store or retrieve the relevant data from the database (second digital information). For example, relevant data may be determined and selected in response to a query (e.g., query included in the first digital information). The outer API may then retrieve the processed data and present it back to the user through the front-end interface, completing the interaction cycle.

In some embodiments, the outer API may be further configured to process the retrieved second digital information. As used herein, processing retrieved digital information refers to a series of operations performed on the data received from back-end systems (e.g., by invoking at least one inner API) to ensure the data is ready for presentation and interaction on the front-end interface. For example, in some embodiments, processing the retrieved second digital information may include filtering the retrieved second digital information to match requirements of the front-end interface. This filtering process may involve tailoring the data retrieved from back-end services to match the specific requirements and constraints of the user interface. In some embodiments, the requirements of the front-end interface may be based on at least one of the channel application or the user device. For instance, a mobile app might require different data or a subset of information compared to a desktop application. Outer APIs may ensure that only the relevant data is passed on to the front-end interface, optimizing performance and user experience. In some other embodiments, processing the retrieved second digital information may include converting a data format of the retrieved second digital information into a structure that is optimized for use by the front-end interface. For example, the at least one inner API may return data in a standard JSON format, this data might not be directly usable by the front-end interface due to differences in structure or required content. Outer APIs may perform the necessary transformations, reformatting the JSON data into a structure that aligns with the needs of the micro front-end components, i.e., a format that is easily consumed by the front-end interface. This transformation may ensure that the user interface can efficiently render and interact with the data without additional processing.

Inner APIs refer to specialized interfaces designed specifically for backend systems within a micro-application architecture. These APIs may serve as a layer of abstraction that facilitates communication and interaction between the micro-application's front-end and its backend systems. By using Inner APIs, micro-applications may achieve loose coupling, meaning they are less dependent on the specific implementation details of the backend systems they interact with. In some embodiments, Inner APIs may adhere to a specific model. For instance, in the context of a digital banking platform, Inner APIs might follow the BIAN (Banking Industry Architecture Network) API Model and utilize the BIAN Object Model (BOM). The BIAN API Model provides standardized guidelines and protocols for defining APIs in the banking domain, ensuring consistency, interoperability, and scalability across different banking services and applications. Meanwhile, the BOM defines a standardized approach to representing banking domain objects and their relationships, enhancing data consistency and compatibility within the micro-application ecosystem.

In some embodiments, the at least one inner API may include at least one of a write inner API or a read inner API. In other words, Inner APIs may be categorized into read inner APIs and write inner APIs based on a Command Query Responsibility Segregation (CQRS) pattern, i.e., a design approach in software engineering that advocates for the separation of concerns between handling write (command) and read (query) operations on data within a system. In some embodiments, the write inner API may be configured to receive the transferred first digital information from the outer API and write the transferred first digital information to a System Of Record (SOR) coupled to the database. An SOR refers to a centralized data storage system coupled or included within a database that is authoritative and holds the official version of a particular set of data within an organization. An SOR may serve as the primary source of truth for specific types of information or transactions. Once the write inner API has received the first digital information from a micro-application it may forward or send this first digital information to the SOR. This process may ensure that the data originating from the micro-application is stored in the authoritative and centralized repository (the SOR), where it becomes the official and trusted record. This integration between the micro-application and the SOR may enable consistent data management, enhance data integrity, and support efficient data access and retrieval across the organization's ecosystem. In some embodiments, the read inner API may be configured to retrieve the second digital information from a system of reference included in the database via a Data Streaming Platform (DSP) and transfer the retrieved second digital information to the outer API. A DSP refers to a software infrastructure that enables the continuous ingestion, processing, and analysis of real-time data streams. A DSP may provide the necessary tools and frameworks to manage and manipulate data streams from various sources in a scalable and efficient manner. The read inner API may send digital information to a micro-application, enabling the micro-application to access and consume real-time data streams processed by the DSP. Additionally, the read inner API may retrieve digital information from a system of reference also referred to as a “book of reference” via the DSP. In the present context, a system of reference or “book of reference” refers to a specific data source or repository managed by the DSP, where historical or reference data is stored and made available for querying and analysis.

In some embodiments, the outer API may include an external API configured to be exposed to an external system. External APIs are designed for access to systems and organizations outside of the primary computer-implemented system. For instance, in the context of a digital banking platform, external APIs might include Open Banking APIs (e.g., QUICKBOOKS, MINT, FINANCIAL DATA EXCHANGE—FDX, etc.). These APIs may provide well-defined endpoints and typically use the REST (Representational State Transfer) architecture over the HTTP (Hypertext Transfer Protocol). External APIs are intended to cater to third-party consumers, such as other financial institutions, fintech companies, and service providers, enabling them to interact with the banking platform's services and data securely and efficiently.

In contrast, internal APIs may be proprietary APIs designed to not be accessible to external or third-party entities. These private APIs may not be available for users outside of the computer-implemented system (e.g., computer-implemented system 100 shown in FIG. 1C) and may be instead intended to improve productivity and communication across different development teams. Some outer APIs may be internal and may not be accessible to third-party entities. In some embodiments, such internal outer APIs may be used with channel applications. Inner APIs, which are closely tied to backend systems such as databases, are considered internal APIs and remain entirely unexposed to external or third-party entities.

FIG. 1C is a schematic representation of exemplary computer-implemented systems 100 for collecting and distributing digital experience information, according to embodiments of the present disclosure. A computer-implemented system 100 for collecting and distributing digital experience information may include a computer-implemented system for developing digital experience applications and a computer-implemented system for processing digital experience information.

System 100 may include one or more channel applications 110, one or more micro-applications 120, one or more sets of write inner application programming interfaces (API) 130, one or more systems of record (SOR) 140, one or more sets of read inner APIs 150, and one or more systems of reference 160. In some embodiments, the system of reference may include a connector configured to receive information corresponding to the detected application events and application states belonging to a category; an event backbone configured to route the information received by the connector based on the category; and a database configured to store the received information. The event backbone may be further configured to send information to the connector from the event backbone and the database based on one or more criteria. The plurality of micro-applications may be further configured to receive information belonging to the category from the connector.

In some embodiments, a channel application 110 may include one or more page components (not shown), configured to lay out and/or configure the micro-applications 120. Micro-applications 120 may each include one or more user interfaces 111 (UI) configured to enable and allow a user to view information or to interact with the system 100. In some embodiments, channel application 100 may be embodied as software stored in a non-transitory computer-readable medium that when executed by a processor causes operations, functions, and results described herein to be realized. A user may use a channel application 110 on a computer, mobile device (e.g., cellular phone, smartphone, tablet, personal digital assistant, smart appliance, kiosk, etc.), or other electronic devices to review or interact with information, for example, with banking information relating to the user's bank account.

A micro-application 120 can be configured to perform one or more discrete functions (e.g., by using logic embodied in computer-readable and/or executable code). The micro-application 120 may include a front-end 124 (i.e. a user interface, which may be a graphical user interface) configured to receive input from a user (e.g., through buttons, or the like) and/or provide information to the user (e.g., through a display, or the like). For example, a micro-application may contain a front-end 124 created using the Angular platform for receiving user input in the form of mouse clicks on a browser. Front-end 124 may be in electronic communication with the user interface 111 of channel application 110. The micro-application may include an outer interface 122 (e.g., an application programming interface (API), or the like) for receiving and sending information from and to the information processing system using the connector (e.g., using an external application programming interface (API), or the like). For example, a micro-application may contain an outer interface created using Bootstrap, and the processing system may contain a corresponding external application interface for communicating with the outer interface. The micro-application may further include an event manager (not shown) configured to send and receive event information to and from the information processing system, as well as a state manager (not shown), configured to send and receive state information to and from the information processing system. For example, in a financial setting, the event manager may publish information regarding business events such as financial transactions by a customer to the event backbone through a system of recording using a first external application programming interface (API), and the state manager may receive information regarding the customer's present account balance from the event backbone using a second external application programming interface (API). In this manner, the read-and-write functionality between micro-applications and the processing system may be scaled differently.

In some embodiments, a write inner API 130 may be configured to receive event information from one or more micro-applications. In some embodiments, the write inner API 130 may send the received event information to one or more systems of record (SOR) 140. SOR 140 may process the event information and update the information to the system of reference 160. In some embodiments, the write inner API 130 may be created using the Micron framework (an open-source framework used for building high-performance, lightweight microservices and serverless applications in Java).

In some embodiments, a read inner API 150 may send information to one or more micro-applications 120. A read inner API 150 may be created by exposing data in a data store. In some embodiments, the read inner API 150 may use an internal or external cache to speed up API responses. In some embodiments, the read inner API 150 may be created using the Micron framework. In some embodiments, the read inner API 150 and the system of reference 160 may be deployed as a central data location 170.

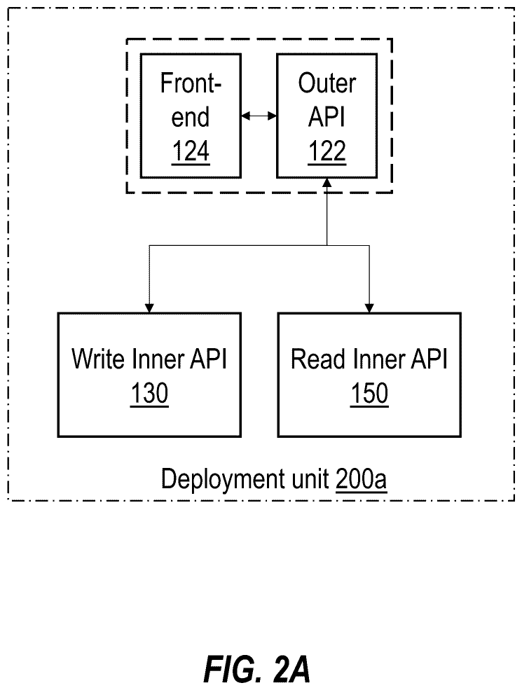

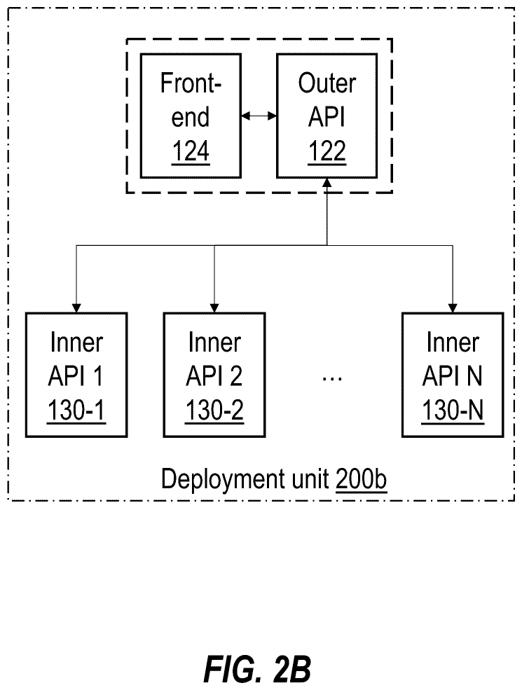

As mentioned earlier, each micro-application 120 may be configured to perform one or more functions or a portion of the functionality of a given channel application 110. In the context of the present disclosure, a “vertical slice” refers to a portion of functionality in a software system that spans all layers of the application stack, from the user interface (UI) down to the data storage layer. Accordingly, consistent with the disclosed embodiments, a vertical slice may include a user interface, such as UI 111, tightly coupled to a front end 124, an outer API 122, and at least one inner API, such as a write inner API 130 and/or a read inner API 150, which may be coupled respectively to a system of record 140 or a system of reference 160. In order to be available for use, a vertical slice needs to be deployed. FIG. 2A illustrates an exemplary deployment unit 200a consistent with the disclosed embodiments. As shown, the deployment unit 200a corresponding to a given micro-application may include a front-end 124, an outer API 122, and at least one of a Write Inner API 130 or a Read Inner API 150. FIG. 2B illustrates another exemplary deployment unit 200b consistent with the disclosed embodiments. As shown, the deployment unit 200b corresponding to a given micro-application may include a front-end 124, an outer API 122, and a plurality of Inner APIs 130-1 through 130-N with N as a natural number.

In some embodiments, the front-end interface, the outer API, and the at least one inner API may be packaged in separate containers. Containers are technologies that enable the packaging and isolation (also referred to as containerization) of applications or micro-applications along with their complete runtime environment, encompassing all the necessary files for execution. The use of containers may facilitate the movement of applications across various environments, such as development, testing, and production while preserving their full functionality. Containers may also enhance IT security. By integrating security measures into the container pipeline and safeguarding the underlying infrastructure, containers may maintain reliability, scalability, and trustworthiness. Moreover, containers may facilitate easy migration of applications between public, private, and hybrid cloud environments, as well as on-premises data centers, ensuring consistent behavior and functionality. The deployment of containerized applications may help mitigate conflicts between development and operations teams by separating their respective responsibilities. Developers can focus on building applications while operations teams can concentrate on managing the infrastructure. Furthermore, in some embodiments, the front-end interface, the outer API, and the at least one inner API may be containerized into the separate containers using a containerization platform, such as Docker (an open-source containerization platform used for building and running containers). Other open-source containerization technologies such as PODMAN, SKOPEO, BUILDAH, CRI-O, or KUBERNETES may be used. The use of open-source containerization platforms/technologies may guarantee access to the latest advances as soon as they become available.

Container technologies may simplify and accelerate application development and deployment, providing orchestration capabilities for streamlined processes. Containers share the underlying operating system kernel and isolate application processes from the rest of the system, enabling seamless movement and utilization across various configurations in development, testing, and production. Due to their lightweight and portable nature, containers offer faster development cycles and the agility to address evolving business requirements. While containers may run within virtual machines (VMs), they are not limited to virtual environments. Containers may provide a higher level of efficiency and flexibility compared to traditional virtualization technologies.

In some embodiments, each separate container (Front-end container, Outer API container, Inner API container) may include a respective port for exchanging digital information. In a containerized environment, containers often need to communicate with each other or with external systems. In this context, ports refer to communication endpoints that allow containers to exchange digital information (e.g., first and second digital information). Each container can be configured to expose one or more ports to facilitate communication with other containers, services, or external clients. By exposing ports, containers may listen for incoming network requests and send out responses or requests. Ports may be labelled using numbers, for example, a container may expose port 8080 for RESTful API requests.

Once its components are containerized, deployment unit 200a/200b may utilize one deployment option. In some embodiments, each micro-application (including a front-end and an outer API) and the at least one inner API may be deployed on the server within in a single pod, the single pod being associated with each micro-application and the at least one inner API. The single pod may be configured to isolate and enable exchange of the first and second digital information between the front-end interface, the outer API and the at least one inner API. In other words, deployment unit 200a/200b may opt for a single pod deployment strategy. In this deployment model, all containerized components within a deployment unit are deployed/bundled together within a single pod. Furthermore, in some embodiments, each micro-application and the at least one inner API may be deployed in the single pod via a container orchestration platform, such as OPENSHIFT or KUBERNETES. KUBERNETES is a container orchestration platform used for orchestrating and managing containers at scale. Organizations may use DOCKER to package their applications into containers and KUBERNETES to manage those containers in production environments. OPENSHIFT is another containerization platform that builds on top of KUBERNETES, and adds additional layers of functionality on top of KUBERNETES, including features such as developer tools, application lifecycle management, security features, and more. OPENSHIFT may provide a more comprehensive solution for building, deploying, and managing containerized applications in production environments, especially in enterprise settings. In container orchestration systems like KUBERNETES and OPENSHIFT, a “pod” serves as the smallest deployable unit, representing a single instance of a running process within the cluster. Pods have their own lifecycle and may be managed as a unit, facilitating horizontal scaling by creating multiple replicas for load balancing and high availability. Despite containing multiple containers, pods may be designed to be immutable, meaning their configuration cannot be altered once created. Any updates may involve creating a new pod with the desired changes and removing the old one.

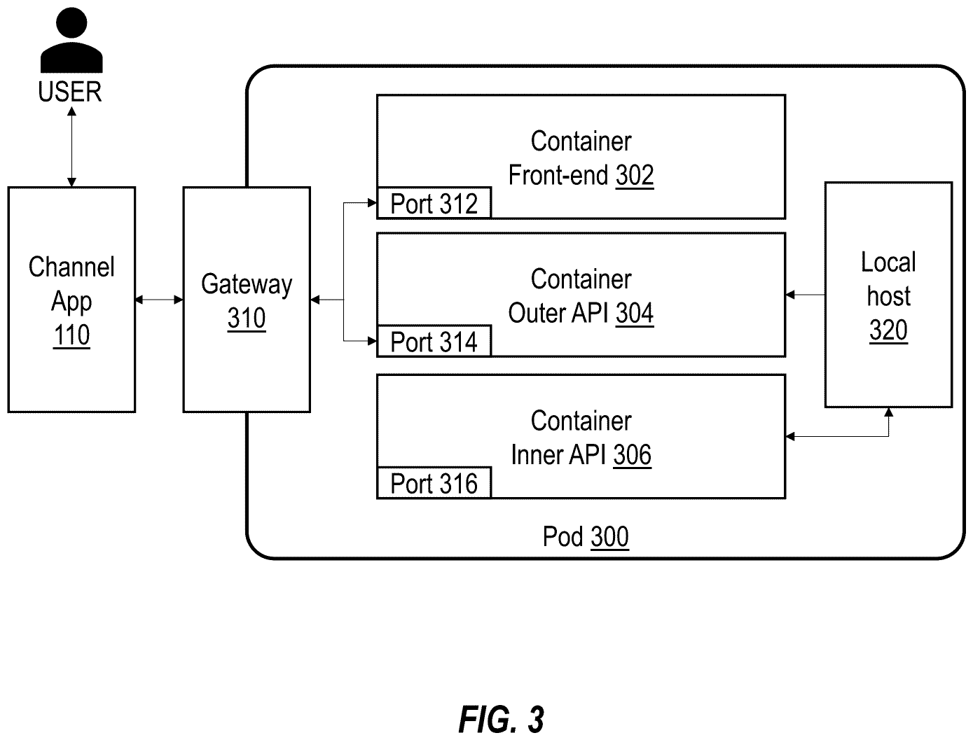

FIG. 3 is a schematic illustration of the single pod deployment model for deployment unit 200a of FIG. 2A. As shown, all the different components of the deployment unit 200a, namely front end 124, outer API 122, and the at least one inner API 130/150 are packaged in separate containers 302, 304, and 306 bundled together within a single pod 300. When a pod contains a plurality of containers, the containers become tightly coupled, meaning that they may share the same network namespace, IP address, and storage volumes. Each container (302, 304, 306) includes a respective port (312, 314, 316) that allows the container to exchange digital information (e.g., first and second digital information). Since all the containers 302, 304, and 306 are deployed within the same pod 306, they may define distinct ports for listening to incoming requests. For example, in some embodiments, container 302 may use port number 8080 (not shown) for port 312, container 304 may use port number 8081 (not shown) for port 314, and container 306 may use port number 8082 (not shown) for port 316. This setup may ensure that each container can receive requests independently.

In some embodiments, each respective port may be coupled to a gateway within the single pod. As used herein, a gateway refers to any component that facilitates communication between the containers within a pod and the external world. For example, in some embodiments, the gateway is configured to enable the exchange of the first and second digital information between the user and the separate containers within the single pod. A gateway may include a router (e.g., OPENSHIFT router), and the container ports (e.g., 8080, 8081, 8082) may be exposed externally via the gateway. The gateway may collect incoming requests from outside the pod. In the exemplary configuration shown in FIG. 3, gateway 310 can receive from the user incoming HTTP or HTTPS requests (through channel app 110, via e.g., a web browser) on ports 80 or 443 (not shown) and forward them to the appropriate containers 302, 304, 306 within the pod based on the port numbers defined by the components (i.e., Front end 124, outer API 122, and inner API 130/150). In the configuration depicted in FIG. 3, since only the front end 124 and the outer API 122 are oriented towards the external world (i.e., towards the user), only their respective containers 302 and 304 are shown as connected to gateway 310. It should be appreciated that in alternative scenarios, container 306 associated with the inner API 130/150 may also be connected to gateway 310. This may be necessary if the inner API needs to handle direct external requests for specific functionalities or data access. The gateway thus plays a role in managing and routing external requests efficiently and may ensure that they reach the correct container based on the specified port numbers. Additionally, the use of a gateway may enhance security by acting as a controlled entry point, where various security policies can be enforced to regulate and monitor the incoming traffic. This architecture may not only ensure a clear separation of concerns between different components but also facilitate scalability and maintainability of the application by allowing individual containers to be updated or scaled independently within the pod.

In some embodiments, the front-end interface, the outer API, and the at least one inner API exchange the first and second digital information via a local host such as local host 320 using the respective port of the separate containers. The term “local host” refers to the hostname that corresponds to the loopback network interface of the local computer. When containers are deployed within a single pod, they may become tightly coupled, allowing them to communicate with each other using the local host and access shared data easily. This internal communication mechanism may leverage the shared network namespace of the pod, enabling containers to interact efficiently without the overhead of external network calls. For example, referring to FIG. 3 the outer API container 304 may orchestrate calls to the inner API container 306 via local host 320 on port 8082 (not shown). Similarly, front-end container 302 may forward requests to the inner API container 306 on port 8082 (not shown). This setup may ensure low-latency communication and simplify the configuration, as all interactions occur within the isolated network environment of the pod. By using local host 320, containers may also take advantage of shared resources such as storage volumes, further enhancing data accessibility and coherence within the pod. This tightly coupled architecture within a pod may provide a robust and efficient environment for micro-application components to interact seamlessly.

It is to be appreciated that the above-described single-pod approach/deployment model contrasts with the single-container per pod deployment model mentioned earlier. Examples of differences between the two deployment models include but are not limited to, in the single-container-per-pod deployment model, each application or container within the deployment unit is deployed in its own separate pod. Containers within these pods may expose the same port for communication, as each container is isolated within its own pod. For example, each container may expose port 8080 (not shown) to listen for incoming requests or to communicate with other services. To expose the container ports externally, a host definition may be configured to map incoming traffic from port 80 (not shown) (commonly used for HTTP) to the respective container ports. Applications within the deployment unit may communicate with each other using service discovery mechanisms.

While the single-container-per-pod model may offer certain advantages, particularly in terms of scalability, developers'decisions on which model to apply may hinge on trade-offs inherent in the deployment process. Opting for larger, multi-container pods may reflect a strategic choice to prioritize the co-location of functionalities within individual pods. As mentioned earlier, this approach may facilitate targeted issue resolution, as developers can readily identify and address problems within a specific feature housed in a single pod, and mitigate security concerns regarding intra-pod traffic control. For example, selecting the single-pod deployment model may be advantageous for a digital banking platform where sensitive account information, such as balance, account holder name, and the last four digits of the account number, is consolidated into a single functional pod. This consolidation may minimize dependencies on other functionalities housed in separate pods within the online banking system, thereby enhancing operational efficiency.

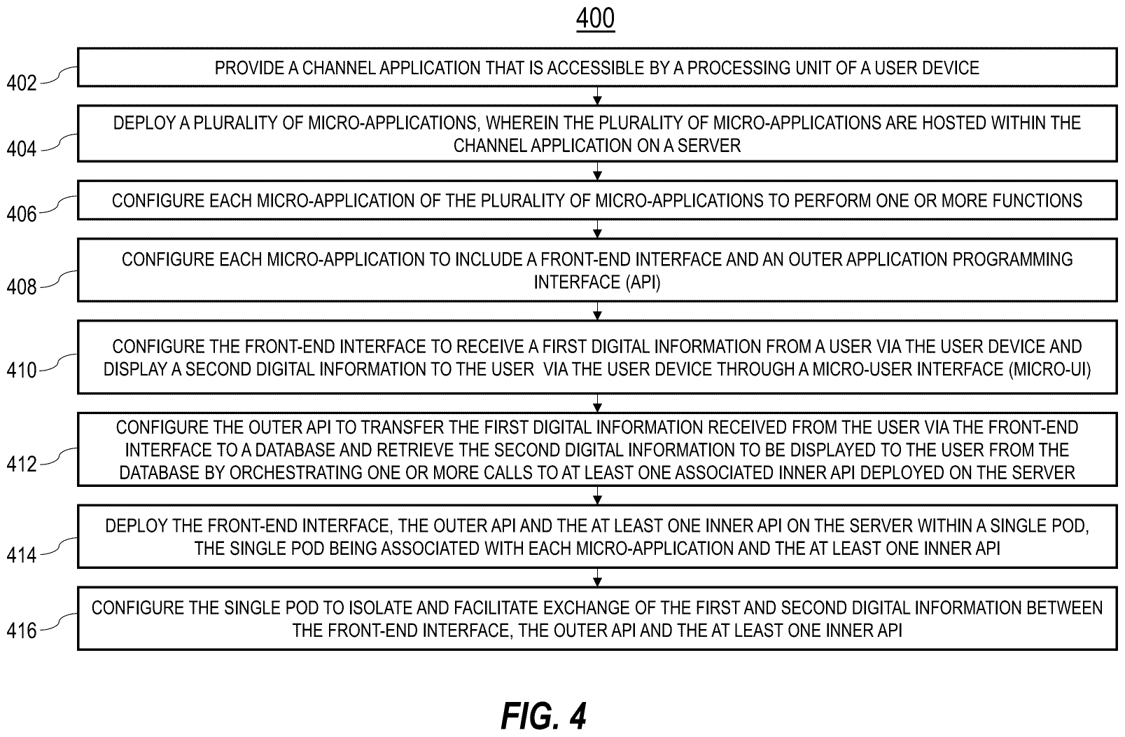

Some embodiments of the present disclosure may involve a non-transitory computer-readable medium for implementing a system designed to collect and distribute digital information. This non-transitory computer-readable medium may contain instructions that, when executed by a processor, enable the processor to perform processes that result in the implementation of the disclosed computer-implemented system for collecting and distributing digital information. FIG. 4 is a flowchart of an exemplary process 400, including instructions for obtaining the disclosed computer-implemented system for collecting and distributing digital information. Details about features of the system for collecting and distributing digital information are those described above with reference to FIGS. 1C-3, which will not be repeated herein.

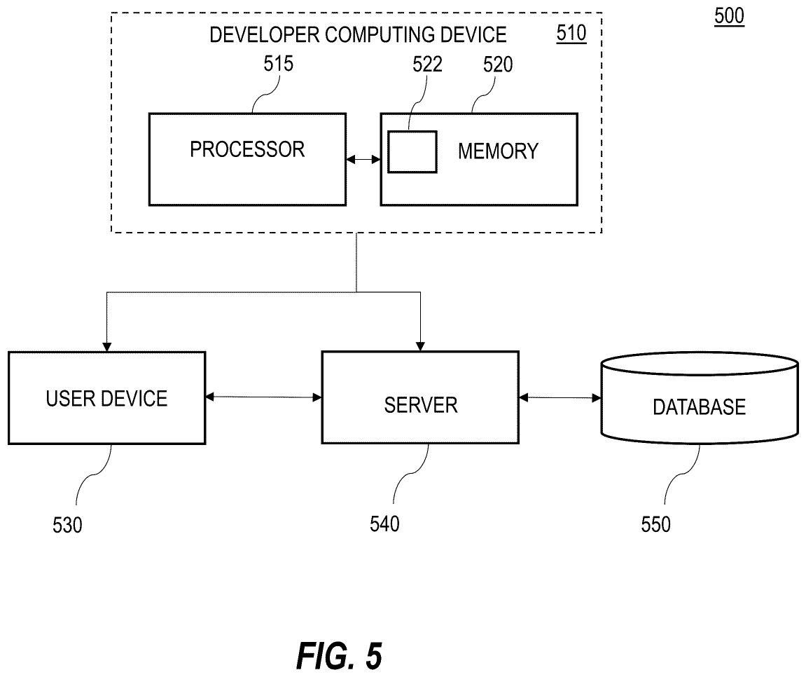

FIG. 5 is an illustration of an exemplary computer system environment 500, including a developer computing device 510, a user device 530, a server 540, and a database 550. User device 530, server 540 and database 550 may collectively represent the computer implemented system 100 shown in FIG. 1C. Developer computing device 510 may include a processor 515 and a memory 520 including a non-transitory computer-readable medium 522, which may contain instructions that, when executed by processor 515, enable processor 515 to perform processes (e.g., process 400) that result in the implementation of computer-implemented system 100 for collecting and distributing digital information (deployed across user device 530, server 540 and database 550). In other words, developer computing device 510 may be employed by a developer (e.g., developers 3 depicted in FIGS. 1A and 1B) to implement computer-implemented system 100.

At step 402, processor 515 may be caused to provide a channel application, that is accessible by a processing unit of a user device. For example, processor 515 may be caused to provide channel application 110, which may be accessed (e.g., downloaded, through a web browser, etc.) by user device 530 (e.g., a desktop, a laptop a smartphone, a tablet, etc.).

At step 404, processor 515 may be caused to deploy a plurality of micro-applications, wherein the plurality of micro-applications are hosted within the channel application on a server. For example, processor 515 may be caused to provide micro-applications 120 hosted within channel application 110 and deployed in server 540.

At step 406, processor 515 may be caused to configure each micro-application of the plurality of micro-applications to perform one or more functions. The one or more functions may collectively represent a user experience within channel application 110.

At step 408, processor 515 may be caused to configure each micro-application of the plurality of micro-applications to include a front-end interface and an outer API.

At step 410, processor 515 may be caused to configure the front-end interface to receive a first digital information from a user via the user device and display a second digital information to the user via the user device through a Micro-User Interface (micro-UI).

At step 412, processor 515 may be caused to configure the outer API to transfer the first digital information received from the user via the front-end interface to a database and retrieve the second digital information to be displayed to the user from the database by orchestrating one or more calls to at least one associated inner API deployed on the server. For example, the outer API may orchestrate calls to the inner API to transfer or retrieve digital information from database 550.

In some embodiments, processor 515 may further configure the outer API to process the retrieved second digital information. For example, in some embodiments, configuring the outer API to process the retrieved second digital information may include configuring the outer API to filter the retrieved second digital information to match requirements of the front-end interface. The requirements of the front-end interface may be based on at least one of the channel application or the user device. Additionally, or alternatively, in some embodiments, configuring the outer API to process the retrieved second digital information may include configuring the outer API to convert a data format of the retrieved second digital information into a structure that is optimized for use by the front-end interface.

In some embodiments, the at least one inner API may include at least one of a write inner API or a read inner API. The write inner API may receive the transferred first digital information from the outer API and write the transferred first digital information to a System Of Record (SOR) coupled to the database. The read inner API may retrieve the second digital information from a book of reference included in the database via a Data Streaming Platform (DSP) and transfer the retrieved second digital information to the outer API. In some embodiments, the outer API may include an external API configured to be exposed to an external system.

In some embodiments, processor 515 may be further configured to deploy the front-end interface, the outer API, and the at least one inner API in separate containers. Processor 515 may be further configured to containerize the front-end interface, the outer API, and the at least one inner API using a containerization platform, such as DOCKER. Each separate container may be configured by processor 515 to include a respective port for exchanging digital information.

At step 414, processor 515 may be caused to deploy the front-end interface, the outer API and the at least one inner API on the server within a single pod, the single pod being associated with each micro-application and the at least one inner API. Processor 515 may be configured to deploy each micro-application and the at least one inner API in the single pod via a container orchestration platform, such as OPENSHIFT or KUBERNETES.

At step 416, processor 515 may be caused to configure the single pod to isolate and enable exchange of the first and second digital information between the front-end interface, the outer API and the at least one inner API.

In some embodiments, processor 515 may be configured to couple each respective port to a gateway within the single pod. Furthermore, in some embodiments, processor 515 may be further configured to configure the gateway to enable the exchange of the first and second digital information between the user and the separate containers within the single pod. Additionally, in some embodiments, processor 515 may be further configured to configure the front-end interface, the outer API, and the at least one inner API to exchange the first and second digital information via a local host using the respective port of the separate containers.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations, and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as examples only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, Android, BLACKBERRY, CHROME OS, WINDOWS XP, WINDOWS VISTA, WINDOWS 7, WINDOWS 8, WINDOWS SERVER, WINDOWS CE, UNIX, LINUX, SUNOS, SOLARIS, VXWORKS, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (GUI), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as examples only, with a true scope and spirit being indicated by the following claims and their full scope of equivalents.

What is claimed is:

1. A computer-implemented system for collecting and distributing digital information, the system comprising:
a memory storing instructions; and
one or more processors of a server configured to execute the stored instructions to provide:
a channel application that is accessible by a processing unit of a user device;
a plurality of micro-applications, hosted within the channel application and deployed on the server, each micro-application configured to perform one or more functions, and each micro-application including a front-end interface and an outer Application Programming Interface (API), wherein:
the front-end interface receives a first digital information from the user device and displays a second digital information to the user device through a Micro-User Interface (micro-UI);
the outer API transfers the first digital information received from the user via the front-end interface to a database and retrieves the second digital information for display to the user from the database by orchestrating one or more calls to at least one inner API deployed on the server; and
the front-end interface, the outer API, and the at least one inner API are deployed on the server within a single pod, the single pod being associated with each micro-application and the at least one inner API, and the single pod configured to isolate and enable exchange of the first and second digital information between the front-end interface, the outer API, and the at least one inner API.

2. The computer-implemented system of claim 1, wherein the at least one inner API includes a write inner API.

3. The computer-implemented system of claim 2, wherein the write inner API is configured to receive the transferred first digital information from the outer API and write the transferred first digital information to a System Of Record (SOR) coupled to the database.

4. The computer-implemented system of claim 1, wherein the at least one inner API includes a read inner API.

5. The computer-implemented system of claim 4, wherein the read inner API is configured to retrieve the second digital information from a system of reference included in the database via a Data Streaming Platform (DSP) and transfer the retrieved second digital information to the outer API.

6. The computer-implemented system of claim 1, wherein the outer API includes an external API configured to be exposed to an external system.

7. The computer-implemented system of claim 1, wherein the front-end interface, the outer API, and the at least one inner API are deployed in separate containers within the single pod.

8. The computer-implemented system of claim 7, wherein the front-end interface, the outer API, and the at least one inner API are containerized into the separate containers using a containerization platform.

9. The computer-implemented system of claim 7, wherein each separate container includes a respective port for exchanging digital information.

10. The computer-implemented system of claim 9, wherein the respective port is coupled to a gateway within the single pod.

11. The computer-implemented system of claim 10, wherein the gateway is configured to enable the exchange of the first and second digital information between the user device and the separate containers within the single pod.

12. The computer-implemented system of claim 9, wherein the front-end interface, the outer API, and the at least one inner API exchange the first and second digital information via a local host using the respective port of the separate containers.

13. The computer-implemented system of claim 1, wherein each micro-application and the at least one inner API are deployed in the single pod via a container orchestration platform.

14. The computer-implemented system of claim 1, wherein the outer API is further configured to process the retrieved second digital information.

15. The computer-implemented system of claim 14, wherein processing the retrieved second digital information includes filtering the retrieved second digital information to match requirements of the front-end interface.

16. The computer-implemented system of claim 15, wherein the requirements of the front-end interface are based on at least one of the channel application or the user device.

17. The computer-implemented system of claim 14, wherein processing the retrieved second digital information includes converting a data format of the retrieved second digital information into a structure that is optimized for use by the front-end interface.

18. A non-transitory computer-readable medium for implementing a system for collecting and distributing digital information, including instructions that, when executed by a processor, cause the processor to:
provide a channel application, that is accessible by a processing unit of a user device;
deploy a plurality of micro-applications, wherein the plurality of micro-applications are hosted within the channel application on a server;
configure each micro-application of the plurality of micro-applications to perform one or more functions;
configure each micro-application to include a front-end interface and an outer Application Programming Interface (API);
configure the front-end interface to receive a first digital information from the user device and display a second digital information to the user device through a Micro-User Interface (micro-UI);
configure the outer API to transfer the first digital information received from the user via the front-end interface to a database and retrieve the second digital information to be displayed to the user from the database by orchestrating one or more calls to at least one associated inner API deployed on the server;
deploy the front-end interface, the outer API, and the at least one inner API on the server within a single pod, the single pod being associated with each micro-application and the at least one inner API; and
configure the single pod to isolate and enable exchange of the first and second digital information between the front-end interface, the outer API, and the at least one inner API.

19. The non-transitory computer-readable medium of claim 18, wherein the at least one inner API includes a write inner API.

20. The non-transitory computer-readable medium of claim 19, wherein the write inner API receives the transferred first digital information from the outer API and writes the transferred first digital information to a System Of Record (SOR) coupled to the database.

21. The non-transitory computer-readable medium of claim 18, wherein the at least one inner API includes a read inner API.

22. The non-transitory computer-readable medium of claim 21, wherein the read inner API retrieves the second digital information from a book of reference included in the database via a Data Streaming Platform (DSP) and transfers the retrieved second digital information to the outer API.

23. The non-transitory computer-readable medium of claim 18, wherein the outer API includes an external API configured to be exposed to an external system.

24. The non-transitory computer-readable medium of claim 18, wherein the processor is further configured to deploy the front-end interface, the outer API, and the at least one inner API in separate containers within the single pod.

25. The non-transitory computer-readable medium of claim 24, wherein the processor is further configured to containerize the front-end interface, the outer API, and the at least one inner API into separate containers using a containerization platform.

26. The non-transitory computer-readable medium of claim 24, wherein each separate container includes a respective port for exchanging digital information.

27. The non-transitory computer-readable medium of claim 26, wherein the processor is further configured to couple each respective port to a gateway within the single pod.

28. The non-transitory computer-readable medium of claim 27, wherein the processor is further configured to configure the gateway to enable the exchange of the first and second digital information between the user and the separate containers within the single pod.

29. The non-transitory computer-readable medium of claim 26, wherein the processor is further configured to configure the front-end interface, the outer API, and the at least one inner API to exchange the first and second digital information via a local host using the respective port of the separate containers.

30. The non-transitory computer-readable medium of claim 18, wherein the processor is further configured to deploy each micro-application and the at least one inner API in the single associated pod via a container orchestration platform.

31. The non-transitory computer-readable medium of claim 18, wherein the processor further configures the outer API to process the retrieved second digital information.

32. The non-transitory computer-readable medium of claim 31, wherein configuring the outer API to process the retrieved second digital information includes configuring the outer API to filter the retrieved second digital information to match requirements of the front-end interface.

33. The non-transitory computer-readable medium of claim 32, wherein the requirements of the front-end interface are based on at least one of the channel application or the user device.

34. The non-transitory computer-readable medium of claim 31, wherein configuring the outer API to process the retrieved second digital information includes configuring the outer API to convert a data format of the retrieved second digital information into a structure that is optimized for use by the front-end interface.
